(19) United States
(12) Patent Application Publication
(10) Pub. No.: US 2023/0271878 A1
(43) Pub. Date: Aug. 31, 2023

(54) CHEMICALLY STRENGTHENED GLASS AND METHOD FOR MANUFACTURING THE SAME

(71) Applicant: AGC Inc., Tokyo (JP)

(72) Inventors: Satoshi OGAMI, Tokyo (JP); Yusuke KATAOKA, Tokyo (JP); Yusuke FUJIWARA, Tokyo (JP)

(73) Assignee: AGC Inc., Tokyo (JP)

(21) Appl. No.: 18/172,432

(22) Filed: Feb. 22, 2023

(30) Foreign Application Priority Data
Feb. 25, 2022 (JP) 2022-028516

(51) Int. Cl. C03C 21/00; C03B 32/02; C03C 10/00

(52) U.S. Cl. CPC C03C 21/002; C03B 32/02; C03C 10/0027

(57) ABSTRACT

The present invention relates to a chemically strengthened glass, satisfying in comparison of an estimated stress profile with an effective stress profile, an absolute value of a difference between tensile stress values at a center in a thickness direction is 30 MPa or smaller, and a value obtained by subtracting, at a depth of 15 μm from a chemically strengthened surface of the glass, a compressive stress value of the effective stress profile from a compressive stress value of the estimated stress profile is 50 MPa or larger.

### CROSS-REFERENCE TO RELATED APPLICATIONS

This application claims priority from Japanese Patent Application No. 2022-028516 filed on Feb. 25, 2022, the entire subject matter of which is incorporated herein by reference.

### TECHNICAL FIELD

The present invention relates to a chemically strengthened glass and a method for manufacturing the same.

### BACKGROUND ART

A chemically strengthened glass is used for, for example, cover glasses of cellphones. A chemically strengthened glass is produced by bringing a glass into contact with a molten salt composition of sodium nitride, for example, and thereby forming a compressive stress layer in the surface part of the glass by causing an ion exchange between alkali metal ions contained in the glass and alkali metal ions that are contained in the molten salt composition and are different in ion radius from the former. The strength of a chemically strengthened glass depends on a stress profile that is represented by compressive stress values (hereinafter, also abbreviated as “CS”) that vary with the depth from the glass surface as a variable.

Cover glasses of cell phones etc. may be broken due to deformation that occurs when they are dropped. To prevent such breaking, that is, breakage by bending, it is effective to increase the compressive stress of the glass surface. To this end, recently, it has become common to produce high surface compressive stress of 700 MPa or higher.

On the other hand, when dropped onto an asphalt surface or sand, cover glasses of cell phones etc. may be broken as a result of collision with a protruding object. To prevent such breaking, that is, breakage by impact, it is effective to form a deep compressive stress layer, to form a compressive stress layer up to a deeper portion of the glass, and to enhance strength of the glass.

However, if a compressive stress layer is formed in the surface part of a glass article, tensile stress (hereinafter, also abbreviated as “CT”) that corresponds to a total amount of surface compressive stress necessarily occurs in a central portion of the glass article. If this tensile stress value is too large, when the glass article is broken, it breaks violently to scatter fragments. If CT is beyond its threshold value (hereinafter, also abbreviated as a “CT limit”), the number of fragments in scratching increases explosively.

In view of the above, in a chemically strengthened glass, a compressive stress layer is formed to a deeper part by setting the compressive stress of the surface high, while the total amount of the compressive stress in a surface layer is designed so that a CT limit is not exceeded (hereinafter, a case that the CT limit is exceeded is also abbreviated as “CT limit excess”). Patent Document 1, for example, discloses a chemically strengthened glass in which CT is controlled in a particular range.
Patent Document 1: JP2017-523110A

### SUMMARY OF INVENTION

As described above, a chemically strengthened glass having an excellent strength property is desired in which breakage by impact can be suppressed by forming a compressive stress layer while avoiding the CT limit excess. On the other hand, there is a problem such that if it is attempted to control CT in a particular range, it takes time for a chemically strengthening treatment to lower the productivity.

An object of the present invention is therefore to provide a chemically strengthened glass having an excellent strength property and an excellent productivity as well as a method for manufacturing the same.

The present inventors have studied the above problems, and completed the present invention by finding out the following to be able to solve the above problems: in comparison of a stress profile derived from an ion concentration profile (hereinafter, also abbreviated as an “estimated stress profile”) with a measured stress profile (hereinafter, also abbreviated as an “effective stress profile”), a difference between compressive stress values in a glass surface layer is within a particular range.

The present invention relates to a chemically strengthened glass in which in comparison of an estimated stress profile defined below with an effective stress profile defined below, an absolute value of a difference between tensile stress values at a center in a thickness direction is 30 MPa or smaller, and a value obtained by subtracting, at a depth of 15 μm from a chemically strengthened surface of the glass, a compressive stress value of the effective stress profile from a compressive stress value of the estimated stress profile is 50 MPa or larger.

The tensile stress at the center in a thickness direction is measured using a scattered light photoelastic stressmeter. As the scattered light photoelastic stressmeter, for example, “SLP-1000” produced by Orihara Industrial Co., Ltd. (hereinafter, abbreviated as “SLP-1000”) can be employed.

The estimated stress profile is a stress profile that is obtained from a Na ion concentration profile measured by an EPMA, and the compressive stress value of the estimated stress profile is represented by σepma (MPa). The σepma (MPa) is obtained according to the following Equations (1) and (2).

The effective stress profile is a stress profile that is measured by a birefringence imaging system Abrio, and the compressive stress value of the effective stress profile is represented by σact (MPa).

σepma=A×fepma+B (1)

Δ=σact−σepma (2).

In Equation (1), fepma represents a compressive stress value in the Na ion concentration profile in the thickness direction of the chemically strengthened glass measured by the EPMA, and σepma is obtained by determining A and B in Equation (1) so as to minimize a square value of a difference Δ between the compressive stress values represented by Equation (2) in a portion deeper than a depth of 50 μm from the chemically strengthened surface.

The thickness direction of the chemically strengthened glass is a direction perpendicular to a glass surface that is in extensive contact with equipment when used as cover glasses.

The present invention relates to a method for manufacturing a chemically strengthened glass including: bringing a lithium-containing glass whose glass transition point Tg at a center in a thickness direction is preferably 600° C. or lower into contact with a molten salt composition to perform an ion exchange N times (N is an integer of 2 or larger), and satisfying the following features (a) and (c), and (b-1) or (b-2):
(a) at least one of first to (N−1)th ion exchanges is an ion exchange of bringing the lithium-containing glass into contact with a first molten salt composition containing sodium nitrate, to obtain a glass having a compressive stress layer containing sodium ions;
(b-1) an Nth ion exchange is an ion exchange of bringing the glass having the compressive stress layer into contact with a second molten salt composition containing potassium nitrate and lithium nitrate, and a mass ratio of a content of lithium nitrate contained in the second molten salt composition to a total content, in terms of oxides, of sodium and lithium in a base composition of the glass having the compressive stress layer ((a mass concentration of LiNO₃ in the second molten salt composition)/(a (Na₂O+Li₂O) mass concentration in the base composition)), is 0.007 or higher;
(b-2) an Nth ion exchange is an ion exchange of bringing the glass having the compressive stress layer into contact with a second molten salt composition containing potassium nitrate and lithium nitrate, and a temperature of the second molten salt composition in the Nth ion exchange is higher than or equal to a temperature of the second molten salt composition in the (N−1)th ion exchange; and
(c) a ratio Tn/Ts of a time Tn of the Nth ion exchange to the sum Ts of all times in the first to (N−1)th ion exchanges is 0.5 or lower.

In the chemically strengthened glass according to the present invention, in comparison of the stress profile derived from the ion concentration profile with the measured stress profile, the difference between the compressive stress values is within the particular range. Accordingly, the chemically strengthened glass according to the present invention exhibits higher strength than before even with a shortened strengthening time to be thus excellent in productivity. Furthermore, the chemically strengthened glass according to the present invention exhibits an excellent strength property because the compressive stress of the glass surface is lowered and the compressive stress in a glass deep layer portion which is effective in increasing the impact resistance upon falling is controlled to a prescribed level or more.

### BRIEF DESCRIPTION OF DRAWINGS

FIG. 1A shows an example of a stress profile according to an embodiment (Example 5) of the present invention in which an estimated stress profile and an effective stress profile are represented by a dotted line and a solid line, respectively;

FIG. 1B shows an example of a stress profile according to the embodiment (Example 6) of the present invention in which an estimated stress profile and an effective stress profile are represented by a dotted line and a solid line, respectively;

FIG. 1C shows a stress profile of Example 1 in which an estimated stress profile and an effective stress profile are represented by a dotted line and a solid line, respectively;

FIG. 1D shows a stress profile of Example 2 in which an estimated stress profile and an effective stress profile are represented by a dotted line and a solid line, respectively;

FIG. 1E shows a stress profile of Example 3 in which an estimated stress profile and an effective stress profile are represented by a dotted line and a solid line, respectively;

FIG. 1F shows a stress profile of Example 4 in which an estimated stress profile and an effective stress profile are represented by a dotted line and a solid line, respectively;

FIGS. 2A and 2B illustrate a method for preparing a glass sample to be used for a refractive index distribution by a two-beam interferometer;

FIG. 3 illustrates a sample used for a measurement of a fracture toughness value K1c by a DCDC method; and

FIG. 4 is a graph showing a K1-v curve that represents a relationship between a stress intensity factor K1 (unit: MPa·m^{1/2}) and a crack development speed v (unit: m/s), and used for the measurement of the fracture toughness value K1c by the DC-DC method.

### DESCRIPTION OF EMBODIMENTS

In this specification, the symbol “-” or the word “to” that is used to express a numerical range includes the numerical values before and after the symbol or the word as the upper limit and the lower limit of the range, respectively. Unless otherwise indicated, “-” has the same meaning herein.

<Chemically Strengthened Glass>

<<Stress Profile>>

In this specification, the term “stress profile” means a pattern in which a stress value is expressed with a depth from a glass surface serving as a variable. Compressive stress and tensile stress are regarded as positive and negative, respectively.

The present invention provides a chemically strengthened glass in which in comparison of an estimated stress profile defined below with an effective stress profile defined below, an absolute value of a difference between tensile stress values at a center in a thickness direction is 30 MPa or smaller, and a value obtained by subtracting, at a depth of 15 μm from the chemically strengthened surface, a compressive stress value of the effective stress profile from a compressive stress value of the estimated stress profile is 50 MPa or larger.

The estimated stress profile is a stress profile that is obtained from a Na ion concentration profile measured by an EPMA, and its compressive stress value is represented by σepma (MPa), and σepma is obtained according to the following Equations (1) and (2).

The effective stress profile is a stress profile that is measured by a birefringence imaging system Abrio, and its compressive stress value is represented by σact (MPa).

σepma=A×fepma+B (1)

Δ=σact−σepma (2)

In Equation (1), fepma represents a compressive stress value in the Na ion concentration profile in the thickness direction of the chemically strengthened glass measured by the EPMA. σepma is obtained by determining A and B in Equation (1) so as to minimize a square value of a difference Δ between compressive stress values represented by Equation (2) in a portion deeper than a depth of 50 μm from the chemically strengthened surface.

(Measurement of Na Ion Concentration by EPMA)

An EPMA is an abbreviation of an electron probe micro analyzer. A measurement of a Na ion concentration by the EPMA is performed in the following manner. An ion concentration of the glass surface is measured using an EPMA (“JXA-8500F” produced by JEOL Ltd.). After a sample is subjected to chemical strengthening, it is embedded in a resin and the cross-section surface perpendicular to a surface of a chemically strengthened layer is mirror-polished. Since a Na ion concentration of the outermost surface is less apt to be measured accurately, the Na ion concentration in a depth direction is calculated in a direction from the center in a thickness direction to the outermost surface, assuming that a signal intensity of Na ions at a position where a signal intensity of Si (considered almost no variation in content) becomes half a signal intensity at a center in a thickness direction corresponds to the Na ion concentration of the outermost surface, and that the signal intensity of Na ions at the center in a thickness direction corresponds to a glass composition before strengthening.

(Stress Measurement by Birefringence Imaging System Abrio)

In a stress measurement by Abrio, the chemically strengthened glass is worked into thin pieces and the cross section perpendicular to the surface of a chemically strengthened layer is mirror-polished, the measurement is then performed from a direction of the polished surface. Specifically, the measurement is performed according to the following procedure using the birefringence image system “Abrio-IM” produced by Tokyo Instruments, Inc.

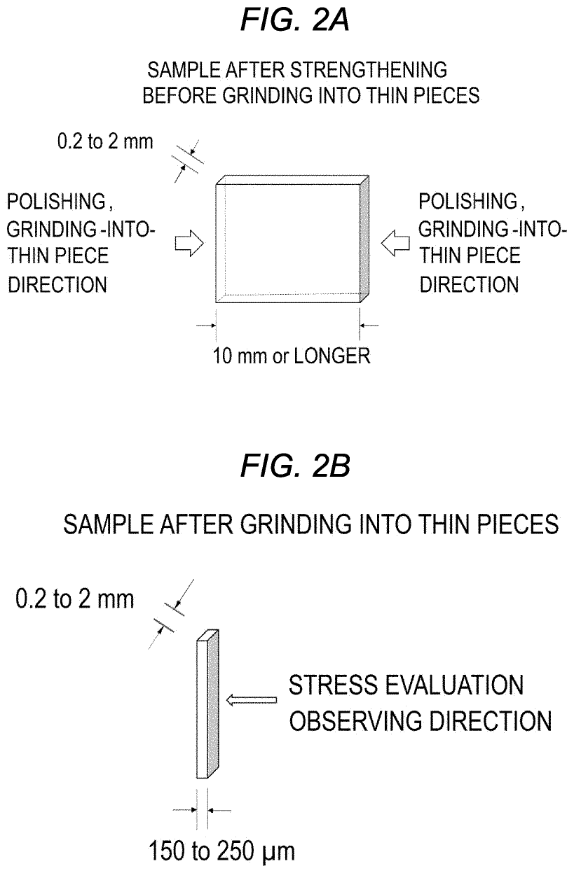

As shown in FIGS. 2A and 2B, the cross section of a sample of a chemically strengthened glass of 10 mm×10 mm or larger in size and about 0.2 to 2 mm in thickness is polished into thin pieces in a range of 150 to 250 μm. A polishing procedure is carried out as follows: the sample is ground to about a target thickness plus 50 μm using a #1,000 diamond electroplated grinding stone; it is then ground to about a target thickness plus 10 μm using a #2,000 diamond electroplated grinding stone; and finally, a mirror surface is formed with cerium oxide to provide the target thickness. With respect to the thus-produced sample worked into thin pieces of about 200 μm, a phase difference (retardation) involved in the chemically strengthened glass is measured with a birefringence imaging system by performing a measurement in transmission light using a light source of a monochrome light having a wavelength λ of 546 nm, and stress is calculated on the basis of a thus-obtained value and the following Equation (i):

F=k×δ/(C×t′) (i)

where F represents a stress value (MPa), k represents a correction coefficient (in this calculation, 1/(1−ν) is used), ν represents a Poisson ratio, δ represents a phase difference (retardation) (nm), C represents a photoelastic coefficient (nm/MPa/cm), and t represents a thickness of the sample (cm).

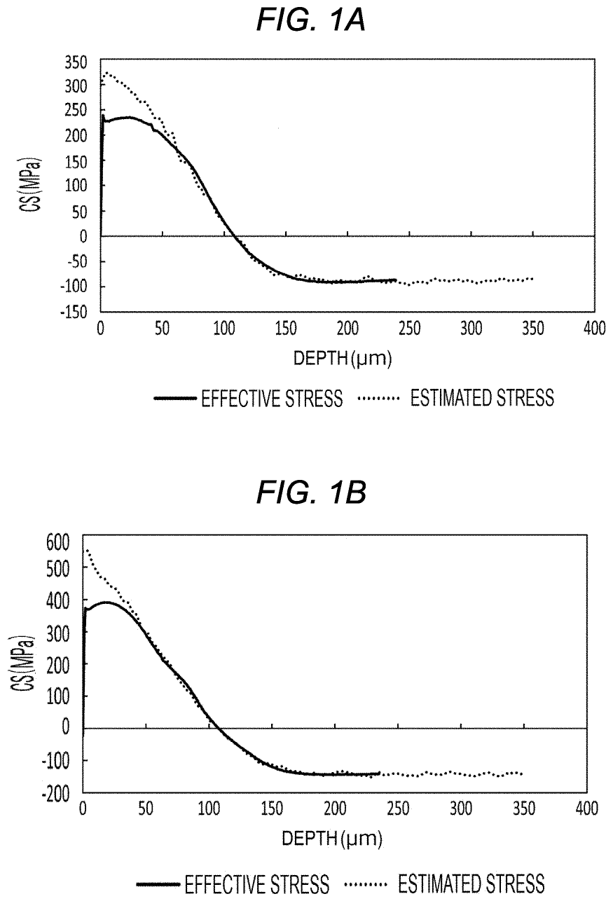

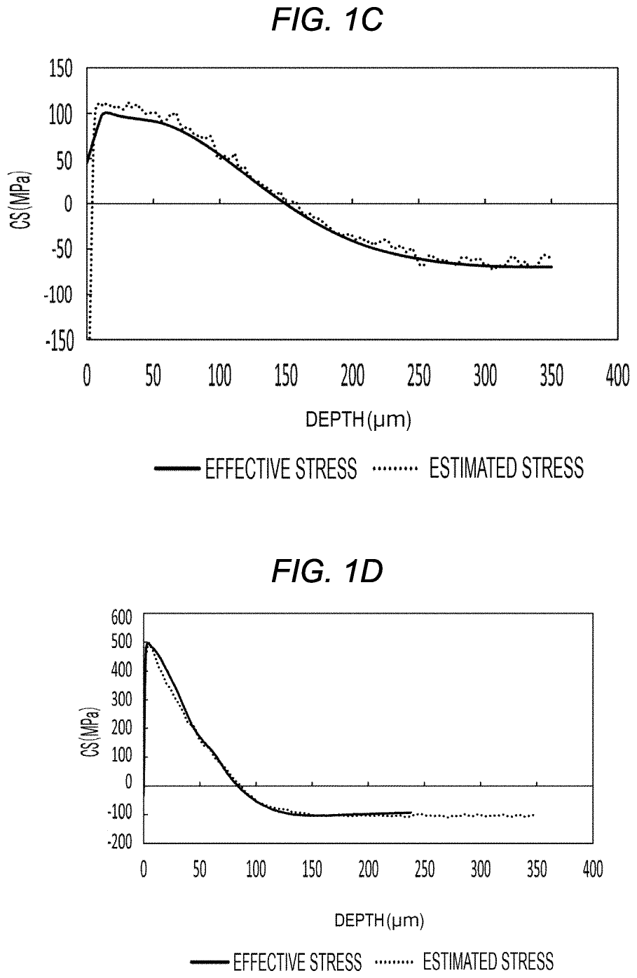

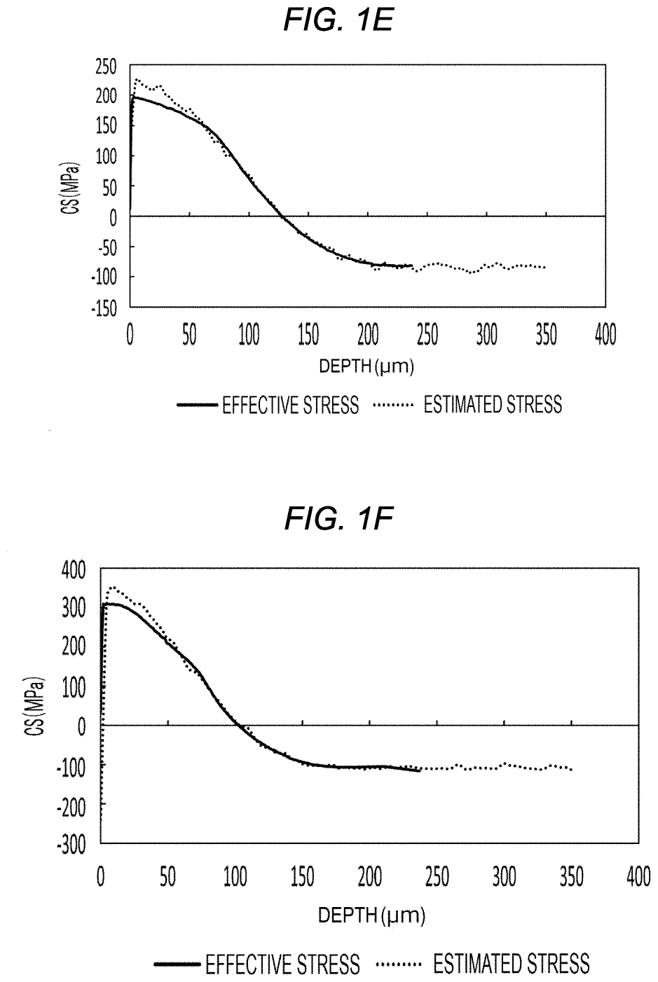

Each of FIGS. 1A and 1B shows an example of stress profiles of the chemically strengthened glass according to the present invention. In each of FIGS. 1A and 1B, an estimated stress profile and an effective stress profile are represented by a dotted line and a solid line, respectively.

As shown in each of FIGS. 1A and 1B, a difference between compressive stress values in the effective stress profile and the estimated stress profile is larger in the glass surface layer compared to the center in a thickness direction. In the chemically strengthened glass according to the present invention, in the glass surface layer, the effective stress profile is smaller than the estimated stress profile; specifically, for example, the effective stress profile is smaller than the estimated stress profile at a depth of 15 μm from the chemically strengthened surface.

In the chemically strengthened glass according to the present invention, a value obtained by subtracting, at the depth of 15 μm from the chemically strengthened surface, a compressive stress value of the effective stress profile from that of the estimated stress profile is 50 MPa or larger. The value is preferably 60 MPa or larger, more preferably 70 MPa or larger, further preferably 80 MPa or larger, particularly preferably 90 MPa or larger, and most preferably 100 MPa or larger. Although there are no particular limitations on the upper limit in the value obtained by subtracting, at the depth of 15 μm from the chemically strengthened surface, the compressive stress value of the effective stress profile from the compressive stress value of the estimated stress profile, it is usually preferable that the value be 500 MPa or smaller.

In the chemically strengthened glass according to the present invention, the absolute value of the difference between the tensile stress values of the estimated stress profile and the effective stress profile at the center in a thickness direction is 30 MPa or smaller, preferably 20 MPa or smaller, more preferably 10 MPa or smaller, further preferably 8 MPa or smaller, particularly preferably 5 MPa or smaller, and most preferably 2 MPa or smaller. Although there are no particular limitations on the lower limit of the absolute value in the difference between the tensile stress values at the center in a thickness direction, it is usually preferable that the absolute value be 0.01 MPa or larger.

In the case where the stress profile has the above-described features, the chemically strengthened glass according to the present invention provides advantages described below: 1) the strengthening time is shortened; 2) the CT limit excess can be avoided; and 3) reduction of the Na ions in the glass surface layer can be suppressed.

1) Shortening of Strengthening Time

In the case where the stress profile has the above-described features, the chemically strengthened glass according to the present invention exhibits an excellent strength property with the strengthening time shorter than before. The present inventors have found that a stress profile having the above-described features can be obtained by performing N times (N is an integer of 2 or larger) an ion exchange that brings glass into contact with a molten salt composition in such a manner that a ratio (Tn/Ts) of a time Tn of an Nth ion exchange to the sum Ts of all times in the first to (N−1)th ion exchanges is preferably 0.5 or higher.

The expression “the ratio (Tn/Ts) of the time Tn of the Nth ion exchange to the sum Ts of all the times in the first to (N−1)th ion exchanges is 0.5 or smaller” means: in the case where an ion exchange is performed twice, when the first ion exchange is performed for 5 hours, the second ion exchange is performed 2.5 hours or shorter.

The stress profile of the chemically strengthened glass according to the present invention is formed by, for example, performing chemical strengthening twice. In the first chemical strengthening, an “Li—Na exchange” occurs mainly in which lithium ions in the glass are replaced by sodium ions in the molten salt composition by bringing a lithium-containing glass into contact with a molten salt composition containing sodium ions.

In the subsequent second chemical strengthening, by using a molten salt composition obtained by adding lithium ions by a small amount to a molten salt composition containing potassium ions, an “Na—K exchange” occurs in which sodium in the glass is replaced by potassium in the molten salt composition and an “Na—Li exchange” also occurs in which sodium in the glass is replaced by lithium in the molten salt composition, whereby the concentration of sodium in the glass surface layer is lowered.

For example, the following reasons (I), (II), and (III) are conceivable as reasons why an excellent strength property is exhibited even in the case where the strengthening time is shortened. The reasons will be described below for an example of a case that an ion exchange by a chemical strengthening treatment is performed twice.

Reason (I): In the case where a crystallized glass containing lithium and having crystals in glass phases is used as glass to be subjected to chemical strengthening, in the first ion exchange, stress is introduced into a glass surface layer by sodium ions and stress is introduced mainly by an ion exchange in the glass phases. In an initial stage (first half) of the second ion exchange, an “Na—Li exchange” in the glass phases precedes. The stress is relieved by a small time of an ion exchange and a large number of sodium ions remain in the crystals. In a latter stage (second half) of the second ion exchange, an “Na—Li exchange” occurs in the crystals later than in the glass phases, whereby a stress profile and a sodium ion concentration distribution come to coincide with each other. The chemically strengthened glass having a stress profile that is obtained in the initial stage of the second ion exchange is obtained by setting the second ion exchange time to be half or less of the first ion exchange time.

Reason (II): In the case where glass to be strengthened is a lithium-containing glass, sodium ions are introduced to alkali ion sites in a glass surface layer by the first ion exchange, whereby the alkali ion sites expand where lithium ions existed before the chemical strengthening and a glass network also expands. By the second ion exchange, sodium in the glass is replaced by lithium in the molten salt composition, whereby lithium ions come to exist at alkali ion sites that are larger in size than alkali ion sites where lithium ions existed in the glass before the chemical strengthening. As a result, the alkali ion sites contract to return to the size before the chemical strengthening and hence the stress come to return to zero, so that stress relaxation not depending on the ion concentration distribution occurs.

Reason (III): Chemical strengthening is performed in such a manner that the radius of alkali ions mainly contained in the first molten salt composition is smaller than that of alkali ions mainly contained in the second molten salt composition and that the temperature of the first molten salt composition is lower than or equal to that of the second molten salt composition. In the first chemical strengthening, sodium ions are introduced thereto, so that stress occurs. In the second chemical strengthening, the main strengthening ions are potassium ions and hence the influence of alkali ions on the intrusion depth of sodium ions is negligible. On the other hand, since that temperature is higher than the temperature of the first chemical strengthening, a glass network around sodium ions becomes softer through heat absorption, whereby alkali ion sites expand to lower the stress. At this time, there exist the stress to be lowered by disappearance of sodium ions and the stress to be lowered by deformation of the glass network and hence stress relaxation irrelevant to the ion concentration distribution occurs.

2) Avoiding of CT Limit Excess

In general, in a chemically strengthened glass, it is considered that the glass can be less prone to break by suppressing expansion of minute cracks in the glass surface by increasing the compressive stress value of the glass surface. It is also considered that even when being subjected to strong impact, the chemically strengthened glass can be less prone to break by setting large the compressive stress layer depth to thus form a compressive stress layer to a deeper portion of the glass. However, if the compressive stress layer is formed on the surface of the glass, a tensile stress layer is necessarily formed inside the glass. If a value of an internal tensile stress is too large, a chemically strengthened glass is prone to break violently in breakage of the glass to scatter fragments.

In the chemically strengthened glass according to the present invention that has the stress profile having the above-described properties, a total value of the compressive stress in the compressive stress layer can be smaller while the crack resistance to impact in falling is higher than in a conventional chemically strengthened glass strengthened by two steps. Thus, the stress value of the tensile stress layer that occurs according to the total value of the compressive stress can be suppressed, so that the CT limit excess can be avoided.

In the chemically strengthened glass according to the present invention, in the case where the stress profile is formed, for example, by a two-step chemical strengthening, in the first-stage chemical strengthening, an “Li—Na exchange” is caused by bringing a lithium-containing glass into contact with a molten salt containing sodium ions, whereby a compressive stress layer is formed on the glass surface, and a tensile stress layer is formed inside the glass. At this time, the compressive stress may be produced up to a range beyond the CT limit.

In the subsequent second-stage chemical strengthening, by using a molten salt composition obtained by adding lithium ions by a small amount to a molten salt composition containing potassium ions, the “Na—K exchange” and the “Na—Li exchange” occur to decrease the concentration of sodium in the glass surface layer. With this measure, the CT limit excess can be avoided while only sodium-origin stress produced in the surface layer (depth of 15 μm, for example) is relieved properly and stress values in a glass deep layer portion (depth of 50 μm, for example) are maintained.

In this specification, the term “CT limit” means a maximum tensile stress value CT at a boundary where the number of fractures changes from 10 or smaller to 10 or larger in a number-of-fractures test as described later in Examples. Accordingly, the CT limit excess is a phenomenon to be preferably avoided industrially for a safety reason. The CT limit is a value that is obtained empirically according to a type of glass and has a negative correlation with the thickness of glass.

3) Suppression in Reduction of Na Ions in Glass Surface Layer

Lowering the sodium ion concentration in the glass surface layer relieves the stress to obtain an advantageous effect for avoiding the CT limit excess. On the other hand, there is a problem that in the case where the sodium ion concentration in the glass surface layer is reduced excessively, the surface stress turns negative, and the surface strength is lowered. In the chemically strengthened glass according to the present invention, since its stress profile has the above-described features, the stress relaxation can be attained without lowering the sodium ion concentration in the glass surface layer excessively. This provides an advantage that an excellent property of preventing strength reduction at the surface can be obtained while the CT limit excess is avoided.

(Slope of Effective Stress Profile)

In the chemically strengthened glass according to the present invention, in the effective stress profile, it is preferable that a slope a₁₅ (MPa/μm) at a depth of 15 μm from the chemically strengthened surface satisfy a₁₅≥−1 and that a slope a₁₅₀ (MPa/μm) at a depth of 150 μm from the chemically strengthened surface satisfy a₁₅₀<0.

The slopes a₁₅ and a₁₅₀ are stress slopes (unit: MPa/μm) that are given by the following respective equations and measured at respective depths 15 μm and 150 μm from the glass surface. Although an average slope in an interval of ±10 μm is employed taking a data variation into consideration, a range of an average to be obtained is not limited to 20 μm.

In the following equations, D represents the depth (unit: μm) from the surface, and the compressive stress CS is measured by the birefringence imaging system Abrio.

CS_{D} is the compressive stress value at the depth (unit: μm) from the glass surface measured by the birefringence imaging system Abrio.

$${a}_{15} = \frac{{\sum }_{D = 5}^{25} ( D - \overline{D} ) ( {CS}_{D} - \overline{CS} )}{{\sum }_{D = 5}^{25} {( D - \overline{D} )}^{2}} \\ {a}_{150} = \frac{{\sum }_{D = 140}^{160} ( D - \overline{D} ) ( {CS}_{D} - \overline{CS} )}{{\sum }_{D = 140}^{160} {( D - \overline{D} )}^{2}}$$

D̅ and C̅S̅ each mean an average value within a range of Z.

In the case where the slopes a₁₅ and a₁₅₀ in the effective stress profile fall within the above-mentioned respective ranges, the shape of the stress profile becomes a convex shape; thus, the stress that occurs in the surface layer is relieved properly and the tensile stress CT can be made smaller than or equal to the CT limit while stress values in a deep portion are maintained.

The slope a₁₅ is preferably −1 or larger, more preferably −0.5 or larger and further preferably 0 or larger. There are no particular limitations on the upper limit of the slope a₁₅.

The slope a₁₅₀ is preferably smaller than 0, more preferably −0.4 or smaller, further preferably −0.8 or smaller, and particularly preferably −1.0 or smaller. There are no particular limitations on the lower limit of the slope a₁₅₀.

(Slope of Estimated Stress Profile)

In the chemically strengthened glass according to the present invention, in the estimated stress profile, it is preferable that a slope e₁₅ (MPa/μm) at the depth of 15 μm from the chemically strengthened surface satisfy e₁₅<0 and that a slope e₁₅₀ at the depth of 150 μm from the chemically strengthened surface satisfy e₁₅₀<0.

The slopes e₁₅ and e₁₅₀ are given by the following respective equations.

In the following equations, the compressive stress CS represents a value obtained from a Na ion concentration profile measured by an EPMA, and a calculation method thereof is described above.

$${e}_{15} = \frac{{\sum }_{D = 5}^{25} ( D - \overline{D} ) ( {CS}_{D} - \overline{CS} )}{{\sum }_{D = 5}^{25} {( D - \overline{D} )}^{2}} \\ {e}_{150} = \frac{{\sum }_{D = 140}^{160} ( D - \overline{D} ) ( {CS}_{D} - \overline{CS} )}{{\sum }_{D = 140}^{160} {( D - \overline{D} )}^{2}}$$

D̅ and C̅S̅ each mean an average value within a range of.

In the case where the slopes e₁₅ and e₁₅₀ in the estimated stress profile fall within the above respective ranges, the stress can be relieved without lowering the sodium concentration in the glass surface layer excessively; thus, an excellent strength property can be exhibited while the strengthening time is shortened and the CT limit excess is avoided.

The slope e₁₅ is preferably smaller than 0, more preferably −0.5 or smaller, further preferably −1.0 or smaller, and particularly preferably −1.5 or smaller. There are no particular limitations on the lower limit of the slope e₁₅.

The slope e₁₅₀ is preferably smaller than 0, more preferably −0.1 or smaller, further preferably −0.2 or smaller, and particularly preferably −0.3 or smaller. There are no particular limitations on the lower limit of the slope e₁₅₀.

(Compressive Stress Values in Effective Stress Profile)

In the chemically strengthened glass according to the present invention, it is preferable that a value (CS₅₀−CS₂₀) obtained by subtracting a compressive stress value CS₂₀ at a depth of 20 μm from the chemically strengthened surface from a compressive stress value CS₅₀ at a depth of 50 μm from the chemically strengthened surface be −150 MPa or larger and 0 MPa or smaller. In the case where (CS₅₀−CS₂₀) is −150 MPa or larger, the compressive stress is introduced to a deep portion of the glass in its thickness direction, which is advantageous for prevention of breakage by collision. With the plate thickness of t (mm), (CS₅₀−CS₂₀) is more preferably (−13t−240) MPa or larger and 0 MPa or smaller, further preferably (−13t−190) MPa or larger and −5 MPa or smaller, and particularly preferably (−13t−100) MPa or larger and −10 MPa or smaller. In the following description of this specification, t represents the plate thickness (mm).

In the effective stress profile, with the plate thickness represented by t (mm), CS₅₀ is preferably (116.62t+17.37) MPa or larger, more preferably (116.62t+67.37) MPa or larger, and further preferably (116.62t+117.37) MPa or larger. There are no particular limitations on the upper limit of CS₅₀.

CS₅₀ is a parameter that contributes to increase of crack resistance to impact in falling. When a glass article drops onto an asphalt-paved road or sand, cracks may develop due to collision with protruding objects of sand and the like. Whereas the lengths of cracks to be developed vary depending on a size of sand with which the glass article collides, in the case where the value of CS₅₀ in the effective stress profile is set at 200 MPa or larger, a stress profile is obtained in which large compressive stress values exist around the depth of 50 μm, as a result of which breaking by crushing due to collision with a relatively large protruding object can be prevented.

In the effective stress profile, a ratio of CS₅₀ to CS₂₀ (CS₅₀/CS₂₀) is preferably 0.5 or larger, more preferably 0.6 or larger, further preferably 0.65 or larger, and particularly preferably 0.7 or larger. (CS₅₀/CS₂₀) being 0.5 or larger is advantageous for prevention of breakage by collision because the compressive stress is introduced to a deep portion of the glass in its thickness direction. There are no particular limitations on the upper limit of (CS₅₀/CS₂₀); it suffices that the CT limit excess be avoided.

In the effective stress profile, it is preferable that a value (CS₉₀−CS₂₀) obtained by subtracting the compressive stress value CS₂₀ at a depth of 20 μm from the chemically strengthened surface from the compressive stress value CS₉₀ at a depth of 90 μm from the chemically strengthened surface be −350 MPa or larger and 0 MPa or smaller. In the case where (CS₉₀−CS₂₀) is −350 MPa or larger, compressive stress is introduced to a deep portion of the glass in its thickness direction, which is advantageous for prevention of breakage by collision. In the case where (CS₉₀−CS₂₀) is 0 MPa or smaller, the CT limit excess can be avoided easily. With the plate thickness represented by t (mm), (CS₉₀−CS₂₀) is preferably (−30t−200) MPa or larger, further preferably (−30t−180) MPa or larger. (CS₉₀−CS₂₀) is more preferably (−13t−5) MPa or smaller, further preferably (−13t−30) MPa or smaller.

In the effective stress profile, with the plate thickness represented by t (mm), CS₉₀ is preferably 30 MPa or larger, more preferably (99.17t−19.42) MPa or larger, further preferably (99.17t−14.42) MPa or larger, even further preferably (99.17t−9.42) MPa or larger, particularly preferably (99.17t+0.58) MPa or larger, and most preferably (99.17t+20.58) MPa. In the case where CS₉₀ is 30 MPa or larger, the stress profile becomes such that large compressive stress values exist in a glass deep layer portion, as a result of which breaking by crushing due to collision with a relatively large protruding object can be prevented. There are no particular limitations on the upper limit of CS₉₀; it suffices that the CT limit excess be avoided.

In the effective stress profile, with the plate thickness represented by t (mm), a ratio of CS₉₀ to CS₂₀ (CS₉₀/CS₂₀) is preferably (0.32t−0.20) or larger, more preferably (0.32t−0.10) or larger, further preferably (0.32t−0.05) or larger, and particularly preferably (0.32t−0.02) or larger. (CS₉₀/CS₂₀) being (0.32t−0.20) or larger is advantageous for prevention of breakage collision because the compressive stress is introduced to a deep portion of the glass in its thickness direction. There are no particular limitations on the upper limit of (CS₉₀/CS₂₀); it suffices that the CT limit excess be avoided.

<<Base Composition of Chemically Strengthened Glass>>

A base composition of the chemically strengthened glass according to the present invention coincides with a composition of glass before the chemical strengthening. The term “base composition” means a composition of regions not influenced by the ion exchange and a composition of regions deeper than a compressive stress layer depth DOL of the chemically strengthened glass except for a case that the glass has been subjected to an extreme ion exchange treatment.

The chemically strengthened glass according to the present invention is preferably a lithium-containing glass, more preferably a lithium aluminosilicate glass. Although the chemically strengthened glass according to the present invention may be a crystallized glass or an amorphous glass, it is preferably a crystallized glass. In the case where glass subjected to the chemical strengthening is a crystallized glass, a chemically strengthened glass obtained by chemically strengthening the glass is also a crystallized glass.

It is preferable that the chemically strengthened glass according to the present invention contains SiO₂, Li₂O, and Al₂O₃ as the base composition.

More preferably, it is preferable that the chemically strengthened glass contain, by mass % in terms of oxides:
40% to 80% of SiO₂;
1% to 35% of Li₂O; and
1% to 20% of Al₂O₃.

It is further preferable that the chemically strengthened glass contain, by mass % in terms of oxides:
50% to 63% of SiO₂;
3% to 21% of Li₂O; and
5% to 19% of Al₂O₃.

In the case where the chemically strengthened glass according to the present invention is a lithium aluminosilicate glass, it is more preferable that the chemically strengthened glass contain, by mass % in terms of oxides, 50% to 80% of SiO₂, 1% to 30% of Li₂O, 1% to 19% of Al₂O₃, 0% to 5% of P₂O₅, 0% to 8% of ZrO₂, 0% to 2% of CaO, 0% to 10% of MgO, 0% to 5% of Y₂O₃, 0% to 10% of B₂O₃, 0% to 6% of Na₂O, 0% to 5% of K₂O, and 0% to 2% of SnO₂ as the base composition.

<<Crystallized Glass>>

It is preferable that the chemically strengthened glass according to the present invention be a crystallized glass because it can achieve an excellent strength property in a shorter strengthening time than before. In the case where the chemically strengthened glass according to the present invention is the crystallized glass, it is preferable that the crystallized glass be a crystallized glass containing at least one of crystal selected from the group consisting of a lithium silicate crystal, a lithium alumino-silicate crystal, and a lithium phosphate crystal. Preferable examples of a lithium silicate crystal include a lithium metasilicate crystal and a lithium disilicate crystal. Preferable examples of a lithium phosphate crystal include a lithium orthophosphate crystal. Preferable examples of a lithium alumino-silicate crystal include a β-spodumene crystal and a petalite crystal.

To increase the mechanical strength, a crystallization ratio of the crystallized glass is preferably 10% or higher, more preferably 15% or higher, further preferably 20% or higher, and particularly preferably 25% or higher. To increase the transparency, the crystallization ratio of the crystallized glass is preferably 70% or lower, more preferably 60% or lower, and particularly preferably 50% or lower. The glass having a low crystallization ratio is excellent in that, for example, it can easily be formed by bending during heating. The crystallization ratio can be calculated from X-ray diffraction intensity by a Rietveld method. The Rietveld method is described in “Crystal Analysis Handbook,” edited by The Crystal Analysis Handbook Editing Committee of the Crystallographic Society of Japan, Kyoritsu Shuppan Co., Ltd., 1,999, pp. 492-499.

To increase the transparency, an average particle diameter of precipitated crystals of the crystallized glass is preferably 300 nm or smaller, more preferably 200 nm or smaller, further preferably 150 nm or smaller, and particularly preferably 100 nm or smaller. The average particle diameter of the precipitated crystals can be obtained from a transmission electron microscope (TEM) image and can be estimated from a scanning electron microscope (SEM) image.

In the case where the chemically strengthened glass according to the present invention is the crystallized glass, it is preferable that the glass contain, by mass % in terms of oxides as the base composition:
40% to 75% of SiO₂;
5% to 35% of Li₂O; and
1% to 20% of Al₂O₃.

It is more preferable that the glass contain, by mass % in terms of oxides as the base composition:
40% to 75% of SiO₂;
5% to 35% of Li₂O;
1% to 20% of Al₂O₃;
0% to 5% of P₂O₅;
0% to 8% of ZrO₂;
0% to 10% of MgO;
0% to 5% of Y₂O₃;
0% to 10% of B₂O₃;
0% to 5% of Na₂O;
0% to 5% of K₂O;
0% to 2% of SnO₂; and
0% to 2% of ZnO.

In this specification, a glass composition is expressed by mass % in terms of oxides and “mass %” is simply denoted by “%” unless otherwise specified. In the glass composition of this specification, the expression “not substantially containing” means that the content of a component is lower than or equal to an impurity level contained in raw materials and the like, that is, the component is not added thereto intentionally. Specifically, for example, the content is lower than 0.1%.

Preferable glass compositions will be hereinafter described.

SiO₂ is a component for forming a glass framework. SiO₂ is also a component for increasing the chemical durability, and a component for reducing occurrence of cracks when the glass surface is scratched.

In the chemically strengthened glass according to the present invention, it is preferable that the content of SiO₂ be 40% or higher. The content of SiO₂ is more preferably 48% or higher, further preferably 50% or higher, particularly preferably 52% or higher, and extremely preferably 54% or higher. On the other hand, to increase the meltability, the content of SiO₂ is preferably 80% or lower, more preferably 75% or lower, further preferably 70% or lower, even further preferably 68% or lower, and particularly preferably 63% or lower.

In the case where the chemically strengthened glass according to the present invention is a lithium aluminosilicate glass, the content of SiO₂ is more preferably 55% or higher, further preferably 58% or higher, and particularly preferably 60% or higher. On the other hand, from the viewpoint of improving meltability, the content of SiO₂ is preferably 75% or lower, more preferably 72% or lower, further preferably 70% or lower, and particularly preferably 68% or lower.

Al₂O₃ is an effective component from the viewpoint of enhancing an ion exchange performance during chemical strengthening to increase the surface compressive stress after the strengthening.

In the chemically strengthened glass according to the present invention, the content of Al₂O₃ is preferably 1% or higher, more preferably 2% or higher, further preferably, in turn, 3% or higher, 5% or higher, 5.5% or higher, and 6% or higher, particularly preferably 6.5% or higher, and most preferably 7% or higher. On the other hand, to prevent the glass devitrification temperature from becoming too high, the content of Al₂O₃ is preferably 20% or lower, more preferably 15% or lower, further preferably 12% or lower, particularly preferably 10% or lower, and most preferably 9% or lower.

Both of SiO₂ and Al₂O₃ are components for stabilizing the glass structure. To lower the brittleness, the sum of their contents is preferably 65% or higher, more preferably 70% or higher, and further preferably 75% or higher.

P₂O₅ is a component for enlarging the compressive stress layer through the chemical strengthening, and may be contained.

In the case where the chemically strengthened glass according to the present invention contains P₂O₅, the content of P₂O₅ is preferably 0.5% or higher, more preferably 1% or higher, further preferably 1.5% or higher, particularly preferably 2% or higher, and extremely preferably 2.5% or higher. On the other hand, in the case where the content of P₂O₅ is too high, phase separation is prone to occur during melting and the acid resistance lowers remarkably. Thus, the content of P₂O₅ is preferably 5% or lower, more preferably 4.8% or lower, further preferably 4.5% or lower, and particularly preferably 4.2% or lower.

Li₂O is indispensable because it is a component for producing surface compressive stress by ion exchange as well as a component of a main crystal.

In the chemically strengthened glass according to the present invention, the content of Li₂O is preferably 1% or higher, more preferably 3% or higher, further preferably 5% or higher, even further preferably 7% or higher, particularly preferably 10% or higher, and most preferably 22% or higher. In the case where the chemically strengthened glass according to the present invention is a crystallized glass, the content of Li₂O is preferably 5% or higher, more preferably 7% or higher, and particularly preferably 10% or higher. On the other hand, to stabilize the glass, the content of Li₂O is preferably 35% or lower, more preferably 30% or lower, further preferably 25% or lower, even further preferably 22% or lower, particularly preferably 20% or lower, and most preferably 18% or lower.

B₂O₃ is a component for increasing the chipping resistance of a glass for chemically strengthening or a chemically strengthened glass, and increasing the meltability, and may be contained. In the case where B₂O₃ is contained, to increase the meltability, the content of B₂O₃ is preferably 0.5% or higher, more preferably 1% or higher, and further preferably 2% or higher. On the other hand, in the case where the content of B₂O₃ is too high, striae occurs or phase separation becomes prone to occur during melting to easily lower the quality of the glass for chemically strengthening, therefore, the content of B₂O₃ is preferably 10% or lower, more preferably 8% or lower, further preferably 6% or lower, and particularly preferably 4% or lower.

Na₂O is a component for increasing meltability of the glass, and may be contained. In the case where Na₂O is contained, the content of Na₂O is preferably 0.5% or higher, more preferably 1% or higher, and particularly preferably 2% or higher. In the case where the content of Na₂O is too high, crystals such as Li₃PO₄ crystals that are main crystals become less apt to precipitate, or properties of chemical strengthening are lowered. Therefore, the content of Na₂O is preferably 6% or lower, more preferably 5% or lower, further preferably 4.5% or lower, even further preferably 4% or lower, and particularly preferably 3.5% or lower. In the case where the chemically strengthened glass according to the present invention is a crystallized glass, the content of Na₂O is preferably 5% or lower, more preferably 4.5% or lower, and further preferably 4% or lower.

K₂O is a component for lowering the glass melting temperature like Na₂O does, and may be contained. In the case where K₂O is contained, the content of K₂O is preferably 0.5% or higher, more preferably 1% or higher, further preferably 1.5% or higher, and particularly preferably 2% or higher. In the case where the content of K₂O is too high, the properties of chemical strengthening or the chemical durability is lowered. Therefore, the content of K₂O is preferably 5% or lower, more preferably 4% or lower, further preferably 3.5% or lower, and particularly preferably 3% or lower.

MgO is a component for stabilizing the glass, and also a component for increasing mechanical strength and resistance to chemicals, therefore, for example, in the case where the content of Al₂O₃ is relatively low, it is preferable that MgO be contained. In the case where MgO is contained, it is preferable that the content of MgO be 1% or higher, more preferably 2% or higher, further preferably 3% or higher, and particularly preferably 4% or higher. On the other hand, in the case where MgO is added thereto too much, the glass viscosity is lowered and devitrification or phase separation is prone to occur, therefore, the content of MgO is preferably 10% or lower, more preferably 9% or lower, further preferably 8% or lower, and particularly preferably 7% or lower.

It is preferable that ZrO₂ be contained because it is a component for increasing the mechanical strength and the chemical durability, and increases CS remarkably. In the case where ZrO₂ is contained, the content of ZrO₂ is preferably 0.5% or higher, more preferably 1% or higher, further preferably 1.5% or higher, particularly preferably 2% or higher, and most preferably 2.5% or higher. On the other hand, to suppress devitrification during melting, the content of ZrO₂ is preferably 8% or lower, more preferably 7.5% or lower, and particularly preferably 6% or lower. In the case where the content of ZrO₂ is too high, the viscosity is lowered because of increase of the devitrification temperature. To suppress degradation in formability due to such lowering in viscosity, in the case where the forming viscosity is low, the content of ZrO₂ is preferably 5% or lower, more preferably 4.5% or lower, and further preferably 3.5% or lower.

CaO is a component for increasing the meltability of the glass, and may be contained. In the case where CaO is contained, the content of CaO is preferably 0.5% or higher, more preferably 1% or higher. On the other hand, since an ion exchange rate is lowered, the content of CaO is preferably 2% or lower, and more preferably 1.5% or lower.

SnO₂ has a function of accelerating generation of crystal nuclei, and may be contained. SnO₂ is not an indispensable component, however, in the case where SnO₂ is contained, the content of SnO₂ is preferably 0.2% or higher, more preferably 0.5% or higher, and further preferably 1.0% or higher. On the other hand, to suppress devitrification during melting, the content of SnO₂ is preferably 2% or lower, and more preferably 1.5% or lower.

ZnO is a component for increasing the meltability of the glass, and may be contained. In the case where ZnO is contained, the content of ZnO is preferably 0.2% or higher, and more preferably 0.5% or higher. On the other hand, since the ion exchange rate is lowered, the content of ZnO is preferably 2% or lower, and more preferably 1.5% or lower.

Each of BaO, SrO, MgO, CaO, and ZnO is a component for increasing the meltability of the glass, and may be contained.

In the case where these components are contained, the sum of the contents of BaO, SrO, MgO, CaO, and ZnO (hereinafter referred to as “BaO+SrO+MgO+CaO+ZnO”) is preferably 0.3% or higher, more preferably 0.5% or higher, further preferably 1.0% or higher, and particularly preferably 2% or higher. On the other hand, since the ion exchange rate is lowered, (BaO+SrO+MgO+CaO+ZnO) is preferably 8% or lower, more preferably 6% or lower, further preferably 5% or lower, and particularly preferably 4% or lower.

<<Glass Transition Point>

In the chemically strengthened glass according to the present invention, the glass transition point (Tg) at a center in a thickness direction is preferably 600° C. or lower, more preferably 595° C. or lower, further preferably 590° C. or lower, and particularly preferably 580° C. or lower. In the case where the glass transition point is 600° C. or lower, stress relaxation occurs easily to exhibit an excellent strength property, irrespective of the ion concentration distribution. Although there are no particular limitations on the lower limit of the glass transition point at the center in a thickness direction, it is preferable that the lower limit be 450° C. or higher from the viewpoint of glass formability.

The glass transition point at the center in a thickness direction is obtained by grinding or pulverizing glass whose composition is the same as a composition at the center in a thickness direction using an agate mortar, putting a resulting powder of about 80 mg into a platinum cell, and measuring a DSC curve using a differential scanning calorimeter (“DSC3300SA” produced by Bruker Corporation) while increasing its temperature from room temperature to 1,100° C. at a rate of temperature increase of 10° C./min. Alternatively, the glass transition point is obtained according to JIS R1618: 2002 from a thermal expansion curve that is obtained at the rate of temperature increase of 10° C./min using a thermal dilatometer (“TD5000SA” produced by Bruker AXS, Inc.). Examples of the glass whose composition is the same as a composition at the center in a thickness direction include glass before the chemical strengthening.

<<Drop Strength>>

In this specification, “#80 drop strength” is measured by the following method. A pseudo-smartphone is prepared by fitting a glass sample of 120 mm×60 mm×0.6 mm (thickness) into a structural body that is adjusted in mass and stiffness for a smartphone having a common size. The pseudo-smartphone is dropped freely onto a #80 SIC sandpaper. The pseudo-smartphone is dropped from a drop height of 5 cm. If the glass sample is not broken, it is dropped again after increasing the drop height by 5 cm. This work is repeated until the glass sample is broken. An average of heights at which 10 individual glass samples are broken for the first time is measured.

In the present chemically strengthened glass, the #80 drop strength is preferably 40 cm or higher, more preferably 50 cm or higher, and further preferably 60 cm or higher. In the case where the #80 drop strength is 40 cm or higher, the present chemically strengthened glass can be prevented from breaking when a cellphone or the like that is equipped with the present chemically strengthened glass as a cover glass is dropped onto rough sand or the like. Although there are no particular limitations on the upper limit of the #80 drop strength, the #80 drop strength is typically 150 cm or lower.

The chemically strengthened glass according to the present invention is useful for a cover glass in electronic devices of, for example, mobile devices such as a cellphone and a smartphone. The chemically strengthened glass according to the present invention is also useful for a cover glass of electronic devices not intended to be portable such as a TV, a personal computer, and a touch panel, an elevator wall surface, and a wall surface (full-surface display) of constructions such as a house and a building. In addition, the chemically strengthened glass according to the present invention is useful for a construction material such as a window glass, a tabletop, an interior material or the like for an automobile, an airplane, and the like and a cover glass thereof, and a case or the like having a curved shape.

<Method for Manufacturing a Chemically Strengthened Glass>

An embodiment of a method for manufacturing the chemically strengthened glass according to the present invention will be described. Glass raw materials are mixed together as appropriate and heat-melted in a glass melting furnace. Subsequently, the resulting glass is uniformized by bubbling, stirring, addition of a clarifying agent, and the like, shaped into a glass plate having a prescribed thickness, and cooled gradually. Alternatively, the glass may be formed in a plate shape by a method including: forming the glass in a block shape; and cutting the cooled glass after gradual cooling.

Examples of a method for forming glass in a plate shape include a float method, a press method, a fusion method, and a downdraw method. In particular, for manufacturing a large-size glass plate, it is preferable to employ the float method. Continuous forming methods other than the float method, for example, the fusion method and the downdraw method are also preferable.

The formed glass is subjected to a chemically strengthening treatment to obtain the chemically strengthened glass. The chemically strengthening treatment is a treatment for replacing metal ions having a small ion radius (typically, lithium ions or sodium ions) in the glass with metal ions having a large ion radius (typically, sodium ions or potassium ions for lithium ions, or potassium ions for sodium ions) in a metal salt by bringing the glass into contact with a metal salt (e.g., potassium nitrate) containing metal ions having a large ion radius (typically, sodium ions or potassium ions) by, for example, a method of immersing the glass in a melt (molten salt composition) of the metal salt. Examples of the above contact include immersion, spraying, coating and so on.

In this specification, the term “molten salt composition” refers to a composition containing a molten salt. Examples of the molten salt contained in the molten salt composition include a nitrate salt, a sulfate salt, a carbonate salt, and a chloride salt. Examples of the nitrate salt include lithium nitrate, sodium nitrate, potassium nitrate, cesium nitrate, rubidium nitrate, and silver nitrate. Examples of the sulfate salt include lithium sulfate, sodium sulfate, potassium sulfate, cesium sulfate, rubidium sulfate, and silver sulfate. Examples of the chloride include lithium chloride, sodium chloride, potassium chloride, cesium chloride, rubidium chloride, and silver chloride. One of these molten salts may be used singly or plural ones of them may be used in combination.

The molten salt composition is preferably one having the nitrate salt as a base, more preferably one having the sodium nitrate and/or potassium nitrate as the base. Here, the expression “having the salt as the base” refers to the content in the molten salt composition being 80 mass % or higher. The total content of sodium nitrate and potassium nitrate is preferably 90 mass % or higher, and more preferably 100 mass %.

The method for manufacturing the chemically strengthened glass according to the present invention (hereafter, also abbreviated as “manufacturing method of the present invention”) is a method for manufacturing the chemically strengthened glass including: performing an ion exchange of bringing a lithium-containing glass whose glass transition point Tg at the center in a thickness direction is preferably 600° C. or lower into contact with a molten salt composition to perform an ion exchange N times (N is an integer of 2 or larger), and the method has the following features (a) and (c) and (b-1) or (b-2):
(a) at least one of first to (N−1)th ion exchanges is an ion exchange of bringing the lithium-containing glass into contact with a first molten salt composition containing sodium nitrate, to obtain a glass having a compressive stress layer containing sodium ions;
(b-1) an Nth ion exchange is an ion exchange of bringing the glass having the compressive stress layer into contact with a second molten salt composition containing potassium nitrate and lithium nitrate, and a ratio ((a LiNO₃ mass concentration in the second molten salt composition)/(a (Na₂O+Li₂O) mass concentration in the base composition)) of a content of lithium nitrate contained in the second molten salt composition (a LiNO₃ mass concentration in the second molten salt composition) to a total content (a (Na₂O+Li₂O) mass concentration in the base composition), in terms of oxides, of sodium and lithium in a base composition of the glass having the compressive stress layer is 0.0035 or higher, or (b-2) an Nth ion exchange is an ion exchange of bringing the glass having the compressive stress layer into contact with a second molten salt composition containing potassium nitrate and lithium nitrate, and a temperature of the second molten salt composition in the Nth ion exchange is higher than or equal to a temperature of the second molten salt composition in the (N−1)th ion exchange; and
(c) a ratio Tn/Ts of a time Tn of the Nth ion exchange to the sum Ts of all times in the first to (N−1)th ion exchanges is 0.5 or lower.

In an embodiment of the manufacturing method of the present invention, from the viewpoints of improving the strength property and increasing the productivity, a temperature of each of the first molten salt composition containing sodium nitrate, and the second molten salt composition containing potassium nitrate and lithium nitrate is preferably (Tg−300)° C. or higher and (Tg−10)° C. or lower, more preferably (Tg−250° C.) or higher and (Tg−20)° C. or lower, and further preferably (Tg−200)° C. or higher and (Tg−30)° C. or lower, Tg being a glass transition point (° C.) of the lithium-containing glass at the center in a thickness direction.

In another embodiment of the manufacturing method of the present invention, from the viewpoints of improving the strength property and increasing the productivity, the temperature of each of the first molten salt composition containing sodium nitrate, and the second molten salt composition containing potassium nitrate and lithium nitrate is preferably (0.5×Tg) (° C.) or higher and (0.9×Tg) (° C.) or lower, more preferably (0.55×Tg) (° C.) or higher and (0.85×Tg) (° C.) or lower and further preferably (0.6×Tg) (° C.) or higher and (0.8×Tg) (° C.) or lower.

In the manufacturing method of the present invention, the glass for chemically strengthening to be subjected to the ion exchanges is a lithium-containing glass, preferably a lithium aluminosilicate glass. Although the glass for chemically strengthening may be a crystallized glass or an amorphous glass, it is preferably a crystallized glass.

<<First to (N−1)th Ion Exchanges>>

In the manufacturing method of the present invention, in at least one of the first to (N−1)th ion exchanges, an ion exchange is performed by bringing the lithium-containing glass into contact with the molten salt composition containing sodium nitrate. With this ion exchange, an “Li—Na exchange” occurs in which lithium ions in the glass are replaced by sodium ions in the molten salt, whereby sodium is introduced to a glass deep layer portion and a deep compressive stress layer containing sodium ions can be formed.

From the viewpoint of introducing a sufficient amount of sodium ions into the inside of the glass, the content of sodium nitrate in the molten salt composition containing sodium nitrate is preferably 30 mass % or higher, more preferably 40 mass % or higher and further preferably 60 mass % or higher. There are no particular limitations on the upper limit of the content of sodium nitrate in the molten salt composition.

The temperature of the molten salt composition containing sodium nitrate is preferably 380° C. or higher, more preferably 400° C. or higher, and further preferably 420° C. or higher. In the case where the temperature of the molten salt composition is 380° C. or higher, an ion exchange proceeds easily and compressive stress can be introduced up to a range beyond the CT limit. Furthermore, from the viewpoints of danger caused by evaporation and a composition change of the molten salt, it is preferable that the temperature of the molten salt composition containing sodium nitrate be usually 450° C. or lower.

The sum of times for which the lithium-containing glass is brought into contact with the molten salt composition containing sodium nitrate in the first to (N−1)th ion exchanges is preferably 0.5 hour or longer, more preferably 1 hour or longer, and further preferably 3 hours or longer. The above times of 0.5 hour or longer is preferable because the surface compressive stress is increased. In the case where the above times are too long, the productivity may be not only lowered, but also the compressive stress may be lowered due to a relaxation phenomenon. For this reason, usually it is preferable that the above times be 8 hours or shorter.

<<Nth Ion Exchange>>

The Nth ion exchange is an ion exchange of bringing the glass having the compressive stress layer containing sodium ions into contact with the molten salt composition containing potassium nitrate and lithium nitrate (hereinafter, as abbreviated as “molten salt composition in the Nth ion exchange”). In the Nth ion exchange, an “Na—K exchange” occurs in which sodium ions in the glass having the compressive stress layer are replaced by potassium ions in the molten salt composition, whereby potassium ions are introduced into a region of dozens of micrometers in a glass surface layer. At the same time, the concentration of sodium ions decreases by an “Na—Li exchange” in which sodium ions in the glass surface layer are replaced by lithium ions in the molten salt composition, whereby the compressive stress due to sodium is relieved. In the Nth ion exchange, the compressive stress in the chemically strengthened glass is relieved so that CT becomes lower than or equal to the CT limit while CS₅₀ in the effective stress profile is preserved.

In an embodiment of the present method for manufacturing the chemically strengthened glass, the Nth ion exchange is an ion exchange of bringing the glass having the compressive stress layer into contact with the molten salt composition containing potassium nitrate and lithium nitrate; in the Nth ion exchange, a mass ratio of the content of lithium nitrate contained in the molten salt composition to the total content, in terms of oxides, of sodium and lithium in the base composition of the glass having the compressive stress layer ((a mass concentration of LiNO₃ in the molten salt composition)/(a (Na₂O+Li₂O) mass concentration in the base composition)) is 0.007 or higher, preferably 0.008 or higher, more preferably 0.009 or higher, and further preferably 0.01 or higher. In the case where the above mass ratio ((the mass concentration of LiNO₃ in the molten salt composition)/(the (Na₂O+Li₂O) mass concentration in the base composition)) is 0.007 or higher, an exchange of sodium ions introduced into the vicinity of the glass surface with lithium ions in the molten salt composition occurs parallel with an exchange of the sodium ions with potassium ions in the molten salt composition, whereby the stress in the glass surface can be lowered.

In another embodiment of the present method for manufacturing the chemically strengthened glass, in the case where the Nth ion exchange is an ion exchange of bringing the glass having the compressive stress layer into contact with the molten salt composition containing potassium nitrate and lithium nitrate, the temperature of the molten salt composition in the Nth ion exchange is higher than or equal to the temperature of the molten salt composition in the (N−1)th ion exchange. In the case where the temperature of the molten salt composition in the Nth ion exchange is higher than or equal to the temperature of the molten salt composition in the (N−1)th ion exchange, an exchange of sodium ions introduced into the vicinity of the glass surface with lithium ions in the molten salt composition occurs parallel with the exchange of the sodium ions with potassium ions in the molten salt composition, whereby the stress in the glass surface can be lowered.

The concentration of potassium nitrate contained in the molten salt composition in the Nth ion exchange is preferably 98 mass % or higher, even preferably 99 mass % or higher, and further preferably 99.5 mass % or higher.

The concentration of lithium nitrate contained in the second molten salt composition in the Nth ion exchange is preferably 0.05 mass % or higher and 10 mass % or lower, more preferably 0.1 mass % or higher and 5 mass % or lower, and further preferably 0.2 mass % or higher and 2.5 mass % or lower. In the case where the concentration of lithium nitrate contained in the second molten salt composition in the Nth ion exchange is in the above range, an exchange of sodium ions introduced into the vicinity of the glass surface with lithium ions in the molten salt composition occurs parallel with the exchange of such sodium ions with potassium ions in the molten salt composition, whereby the stress in the glass surface can be lowered.

Potassium ions/lithium ions (mass ratio) of potassium ions contained in the second molten salt composition in the Nth ion exchange to lithium ions contained in the same is preferably 100 or higher and 1,249 or lower, more preferably 100 or higher and 2,500 or lower, further preferably 200 higher and 2,250 or lower, and particularly preferably 300 higher and 2,000 or lower. The potassium ions/lithium ions (mass ratio) being in the above range means that lithium ions are added to the molten salt composition intentionally. The intentional addition of lithium ions makes it possible to cause an “Na—Li exchange” effectively in which sodium ions in the glass are replaced lithium ions in the molten salt composition, whereby the compressive stress produced in the glass surface layer in the first to (N−1)th ion exchanges can be lowered.

The molten salt composition in the Nth ion exchange may also contain an additive other than the nitrate salt. Examples of the additive include silicic acid and a particular inorganic salt. In the case where the molten salt composition in the Nth ion exchange may contain silicic acid, since silicic acid absorbs lithium ions to facilitate entrance of potassium ions into the glass, the stress in a surface layer of several micrometers in the effective stress profile can be increased.

The “silicic acid” refers to a compound made of silicon, hydrogen, and oxygen and represented by a chemical formula of nSiO₂·xH₂O, where n and x are natural numbers. Examples of such silicic acid include metasilicic acid (SiO₂·H₂O), metadisilicic acid (2SiO₂·H₂O), ortho-silicic acid (SiO₂·2H₂O), pyrosilicic acid (2SiO₂·3H₂O), silica gel [(SiO₂·mH₂O), m: real number of 0.1 to 1]. Among these examples, silica gel [(SiO₂·mH₂O, m: real number of 0.1 to 1)] is preferable.

Silica gel is advantageous in that it tends to settle out in a molten salt because secondary particles thereof are relatively large and hence it can be fed and collected easily. Furthermore, silica gel having no risk by scattering-out of dust particles can secure the safety of workers. Furthermore, silica gel is a porous material and a molten salt is easily supplied to the surfaces of primary particles. Thus silica gel is excellent in reactivity to provide a large effect for absorbing lithium ions.

The content of silicic acid contained in the molten salt composition in the Nth ion exchange is preferably 0.1 mass % or higher, more preferably 0.3 mass % or higher, and most preferably 0.5 mass % or higher. In addition, the content of silicic acid is preferably 3 mass % or lower; more preferably 2 mass % or lower, and most preferably 1 mass % or lower.

The molten salt composition in the Nth ion exchange may contain an inorganic salt (hereinafter referred to as “flux”) as an additive. Preferable examples of the flux include a carbonate, a hydrogen carbonate, a phosphate, a sulfate, a hydride, and a chloride. At least one salt selected from the group consisting of K₂CO₃, Na₂CO₃, KHCO₃, NaHCO₃, K₃PO₄, Na₃PO₄, K₂SO₄, Na₂SO₄, KOH, NaOH, KCL, and NaCl is preferable; in particular, at least one salt selected from the group consisting K₂CO₃ and Na₂CO₃ is more preferable; K₂CO₃ is even more preferable.

In the case where the content of the flux in the molten salt composition in the Nth ion exchange is preferably 0.1 mass % or higher, an effect of increasing CS₀ can be obtained easily. On the other hand, to suppress variations in property of the glass surface, the content of the flux is usually preferably 2 mass % or lower, and more preferably 1 mass % or lower.

The temperature of the molten salt composition in the Nth ion exchange is preferably 380° C. or higher, more preferably 400° C. or higher, and further preferably 420° C. or higher. In the case where the temperature of the molten salt composition is 380° C. or higher, an ion exchange proceeds easily and the compressive stress can be introduced to a range beyond the CT limit. Furthermore, from the viewpoints of danger caused by evaporation and a composition change of the molten salt, it is preferable that the temperature of the molten salt composition in the Nth ion exchange be 450° C. or lower. Moreover, from the viewpoints of the above-described reasons (I), (II) and (III), since diffusion is related to heat, the temperature of the molten salt composition in the Nth ion exchange is preferably (Tg−180)° C. or higher, in turn, more preferably (Tg−160)° C. or higher, (Tg−140)° C. or higher, and (Tg−120)° C. or higher.

A contact time between the molten salt composition and the glass in the Nth ion exchange is preferably 3 hours or shorter, more preferably 2 hours or shorter, and further preferably 0.5 hour or shorter. In the case where the contact time is 0.25 hour or longer, an exchange between sodium ions introduced in the vicinity of the glass surface by the (N−1)th ion exchange and lithium ions in the molten salt composition used in the Nth ion exchange occurs sufficiently, whereby the stress of the glass surface can be lowered easily. From the viewpoint of preventing excessive stress reduction by “Na—Li exchange”, usually it is preferable that the contact time be 1.5 hours or shorter.

In the manufacturing method of the present invention, the ratio Tn/Ts of the time Tn in the Nth ion exchange to the sum Ts of all times in the first to (N−1)th ion exchanges is 0.5 or lower, more preferably 0.3 or lower, further preferably 0.2 or lower, and particularly preferably 0.1 or lower. According to the manufacturing method of the present invention, even in the case where the ion exchange time is shorter than before with Tn/Ts of 0.5 or lower, the chemically strengthened glass that has the above-described stress profile and exhibits an excellent strength property can be obtained. Although there are no particular limitations on the lower limit of Tn/Ts, it is preferable that Tn/Ts be usually 0.05 or higher from the viewpoint of obtaining sufficient strength.

### EXAMPLE

Although the present invention will be hereinafter described in accordance with Examples, the present invention is not limited thereto.

[Production of Sample]

(1) Production of Glass

Glass raw materials were mixed together so as to obtain a composition shown in Table 1 by indication of mass percentage in terms of oxides, and weighed so as to produce glass of 400 g. Then, the mixed materials were put into a platinum crucible, placed in an electric furnace of 1,500° C. to 1,700° C., melted for about 3 hours, defoamed, and uniformized.

The obtained molten glass was poured into a metal die, kept at a temperature higher than a glass transition point by about 50° C. for 1 hour, and then cooled to room temperature at a rate of 0.5° C./min, whereby a glass block of mother glass was obtained.

(2) Production of Crystallized Glass

After the obtained glass was worked into a size of 50 mm×50 mm×1.5 mm, a crystallized glass was obtained on conditions shown in Table 1. Precipitated crystals were analyzed by powder X-ray diffraction. As a heat treatment for crystallization, a heat treatment was performed under temperatures and times shown in the first row of the heat treatment condition row of Table 1, and then the heat treatment was performed under temperatures and times shown in the second row of the heat treatment condition row of Table 1.

(3) Production of Sample

The glass obtained in (2) was worked and mirror-polished into a glass plate having a thickness t of 0.7 mm. For the crystallized glass, part of remaining crystallized glass was ground or pulverized so as to be used for an analysis of precipitated crystals.

After the glass plate was heated preliminarily at 350° C. for 10 minutes, ion exchanges were performed under conditions shown in Table 2 to obtain a chemically strengthened glass. In the first chemical strengthening treatment, a chemical strengthening treatment was performed by holding a temperature shown in the temperature row of Table 2 for a time shown in the time row of Table 2 using a molten salt composition shown in the first ion exchange row of Table 2.

Subsequently, in the second chemical strengthening treatment, a chemical strengthening treatment was performed by holding a temperature shown in the temperature row of Table 2 for a time shown in a time row of Table 2 using a molten salt composition shown in the second ion exchange row of Table 2. In the second ion exchange row of Table 2, “(LiNO₃ (mass %))/(Na₂O+Li₂O (mass %))” represents a ratio of a content (mass %) of lithium nitrate contained in the second molten salt composition to a total content (mass %), in terms of oxides, of sodium and lithium in the glass subjected to the second ion exchange.

[Mother Glass and Crystalized Glass Evaluation Method]

The mother glass and the crystallized glass obtained by the above method were evaluated by the following methods. The results are shown in Table 1.

(Glass Transition Point Tg)

A glass transition point Tg (unit: ° C.) was obtained by grinding or pulverizing the glass using an agate mortar, putting a powder of about 80 mg into a platinum cell, and measuring a DSC curve using a differential scanning calorimeter (“DSC3300SA” produced by Bruker Corporation) while increasing its temperature from room temperature to 1,100° C. at a temperature increase rate of 10° C./min.

Alternatively, a glass transition point Tg (unit: ° C.) was obtained according to JIS R1618: 2002 from a thermal expansion curve that was obtained at a temperature increase rate of 10° C./min using a thermal dilatometer (“TD5000SA” produced by Bruker AXS, Inc.).

(Devitrification Temperature)

A devitrification temperature T was obtained by the following manner. The glass was ground or pulverized and resulting pieces were classified using a sieve of 4-mm mesh and 2-mm mesh, cleaned by pure water, and dried to obtain cullet. After the cullet of 2 to 5 g was placed on a platinum plate and held for 17 hours in an electric furnace kept at a constant temperature, it was taken out from the furnace into room-temperature air, and cooled; thereafter, the resultant is subjected to an operation of observing presence or absence of devitrification using a polarizing microscope. The operation was repeated to estimate the devitrification temperature T.

(Devitrification Viscosity)

As for devitrification viscosity, a viscosity measurement was performed using a rotary high-temperature viscometer while the temperature was decreased from 1,700° C. to 1,000° C. (or until the viscosity came to increase rapidly by devitrification) at a rate of 10° C./min and a viscosity value at the above devitrification temperature was provided as devitrification viscosity log η.

(Specific Gravity ρ)

A specific gravity was measured by an Archimedes method.

(Haze Value)

A haze value (unit: %) was measured in a halogen lamp (C light source) using a haze meter (“HZ-V3” produced by Suga Test Instruments Co., Ltd.).

(Young's Modulus E)

A Young's modulus E was measured by an ultrasonic pulse method (JIS R1602).

(X-Ray Diffraction: Precipitated Crystals)

Part of the crystallized glass was ground or pulverized, and precipitated crystals were identified by performing a powder X-ray diffraction measurement under the following conditions. Furthermore, crystallinity was calculated by a Rietveld method from obtained diffraction intensities.
Measuring instrument: “SmartLab” produced by Rigaku Corporation;
X-ray used: CuKα ray
measurement range: 20=100 to 800
speed: 10°/min; and
step: 0.02°.

(Fracture Toughness Value Kc)

Kc was measured by an IF method according to JIS R1607: 2015.

(Fracture Toughness Value K1c)

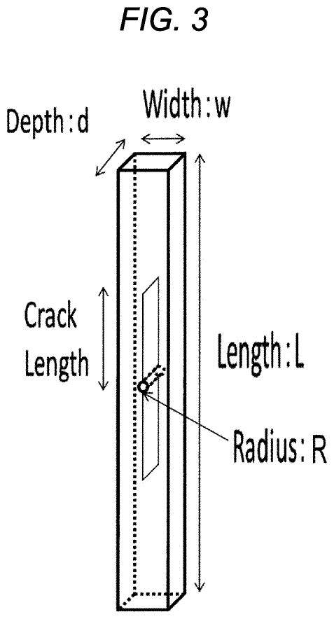

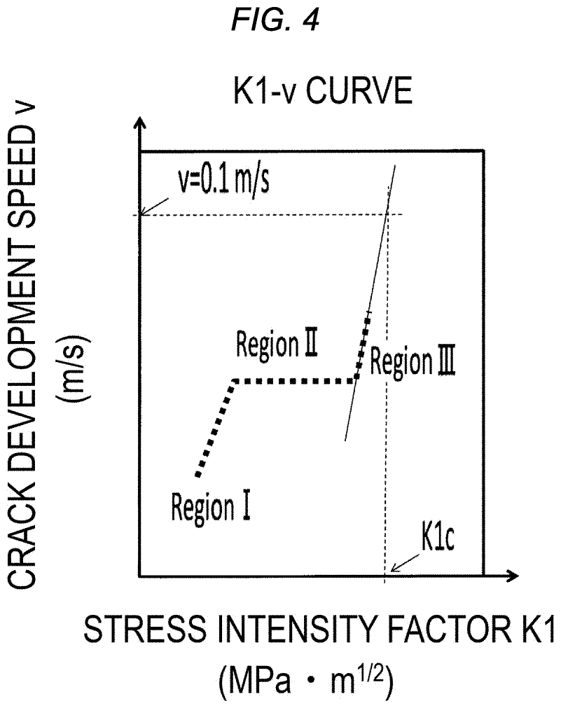

A fracture toughness value K1c (unit: MPa·m^{1/2}) was measured by a DCDC method. Using a method described in M. Y. He, M. R. Turner, and A. G. Evans, Acta Metall. Mater., 43 (1995), p. 3,453 as a reference, a K1-v curve as shown in FIG. 4 indicating a relationship between a stress intensity factor K1 (unit: MPa·m^{1/2}) and a crack development speed v (unit: m/s) was measured by a DCDC method using a sample having a shape shown in FIG. 3 and a SHIMADZU autograph “AGS-X5KN”; the obtained data in region III were subjected to regression and extrapolation by a linear expression, and a stress intensity factor K1 at 0.1 m/s was provided as a fracture toughness value K1c.

[Chemically Strengthened Glass Evaluation Method]

The above-obtained chemically strengthened glass was evaluated by the following method. The results are shown in Table 2. In Table 2, Examples 1-4 are Comparative Examples and Examples 5-7 are Inventive Examples. Stress profiles of Examples 1-6 are shown in FIGS. 1A-1F.

(Stress Profile)

(1) Estimated Stress Profile and Effective Stress Profile

The estimated stress profile is a stress profile obtained from a Na ion concentration profile measured by an EPMA, and a compressive stress value is represented by σepma (MPa). σepma was obtained according to the following Equations (1) and (2).

The effective stress profile is a stress profile measured by the birefringence imaging system Abrio, and a compressive stress value is represented by σact (MPa).

In the following Equation (1), fepma represents a compressive stress value in a Na ion concentration in a thickness direction of the chemically strengthened glass measured by the EPMA. σepma was determined by determining A and B in the following Equation (1) so as to minimize the square of a compressive stress value difference Δ represented by the following Equation (2) at a portion that is deeper than 50 μm in depth from the surface.

σepma=A×fepma+B (1)

Δ=σact−σepma (2)

(2) Stress Measurement by Abrio

In a stress measurement by Abrio, a chemically strengthened glass was worked into a thin plate and a cross section perpendicular to the surface of a chemically strengthened layer was mirror-polished; the measurement was then performed from a direction of the polished surface. Specifically, the measurement was performed according to the following procedure using a birefringence image system “Abrio-IM” produced by Tokyo Instruments, Inc.

As shown in FIGS. 2A and 2B, a cross-section surface of a sample of a chemically strengthened glass of 10 mm×10 mm or larger in size and about 0.2 to 2 mm in thickness was polished into thin pieces in a range of 150 to 250 μm. A polishing procedure is carried out as follows, the sample was ground to about a target thickness plus 50 μm using a #1,000 diamond electroplated grinding stone; it was then ground to about a target thickness plus 10 μm using a #2,000 diamond electroplated grinding stone; and finally a mirror surface was formed with cerium oxide to provide the target thickness. With respect to the thus-produced sample worked into thin pieces of about 200 μm, a phase difference (retardation) involved in the chemically strengthened glass was measured with the birefringence imaging system by performing a measurement in transmission light using a light source that emits monochrome light having a wavelength λ of 546 nm, and stress was calculated on the basis of the obtained value and the following Equation (i):

F=k×δ/(C×t′) (i)

where F represents a stress value (MPa), k represents a correction coefficient (in this calculation, 1/(1−ν) was used), ν represents a Poisson ratio, S represents a phase difference (retardation) (nm), C represents a photoelastic coefficient (nm/MPa/cm), and t′ represents a thickness of the sample (cm).

(3) Measurement of Na Ion Concentration by EPMA

A measurement of a Na ion concentration by the EPMA was performed in the following manner. An ion concentration of the glass surface was measured using an EPMA (“JXA-8500F” produced by JEOL Ltd.). A sample subjected to chemical strengthening was embedded in a resin and mirror-polished. Since a Na ion concentration of the outermost surface is less apt to be measured accurately, the Na ion concentration in a depth direction was calculated in a direction from the center in a thickness direction to the outermost surface, assuming that a signal intensity of Na ions at a position where a signal intensity of Si (considered almost no variation in content) becomes half a signal intensity at a center in a thickness direction corresponds to the Na ion concentration of the outermost surface, and that the signal intensity of Na ions at the center in a thickness direction corresponds to a glass composition before strengthening.

(Drop Strength Test)

A pseudo-smartphone was prepared by fitting a glass sample of 120 mm×60 mm×0.6 mm (thickness) into a structural body that is adjusted in mass and stiffness for a smartphone having a common size. The pseudo-smartphone was dropped freely onto a #80 SIC sandpaper. The pseudo-smartphone was dropped from a drop height of 5 cm. If the glass sample was not broken, it was dropped again after increasing the drop height by 5 cm. This work was repeated until the glass sample was broken. An average of heights at which 10 individual glass samples were broken for the first time was measured. The results are shown as values of “drop strength” in Table 2.

TABLE 1

| | | Glass | Glass |
|---|---|---|---|
| | | material Z | material A |
| Mother glass | SiO₂ | 64 | 61 |
| composition | Al₂O₃ | 19.5 | 8.5 |
| (mass %) | P₂O₅ | 0 | 4.7 |
| | MgO | 0.1 | 3.36 |
| | K₂O | 1.7 | 0 |
| | Na₂O | 4.5 | 2.1 |
| | Li₂O | 4.9 | 10.5 |
| | CaO | 0.1 | 0 |
| | ZrO₂ | 0.6 | 6.2 |
| | TiO₂ | 0.1 | 0 |
| | Y₂O₃ | 4.5 | 3.8 |
| | Total | 100 | 100 |
| Mother glass | Tg (° C.) | 610 | 513 |
| | Devitrification | 1,210-1,250 | 1,160-1,750 |
| | temperature (° C.) | | |
| | Devitrification viscosity | 3.8-4.0 | 2.6-2.7 |
| | (logη) | | |
| | Young's modulus (GPa) | 85 | 90 |
| | Kc (MPa · m^{1/2}) | 1.1 | 0.98 |
| | K1c (MPa · m^{1/2}) | 0.81 | 0.85 |
| Crystallized | Main crystal | — | Li₃PO₄ |
| glass | Haze (%) | — | 0.03 |
| | Tg (° C.) | — | 513 |
| | Specific gravity (g/cm³) | — | 2.56 |
| | Young's modulus (GPa) | — | 95 |
| | Kc (MPa · m^{1/2}) | — | 0.95 |
| | K1c (MPa · m^{1/2}) | — | 0.89 |
| | Heat treatment conditions | — | 550° C.-2 h |
| | (° C.-2/° C.-h) | — | 750° C.-2 h |

TABLE 2

| | | Example 1 | | Example 2 | Example 3 | | Example 4 | |
|---|---|---|---|---|---|---|---|---|
| Glass material | | Z | | A | A | | A | |
| Glass material | Li concentration (mass %) | 4.9 | | 10.5 | 10.5 | | 10.5 | |
| Thickness (mm) | | 0.709 | | 0.704 | 0.705 | | 0.704 | |
| First ion | First molten salt composition (mass %) | NaNO₃ 100 | | NaNO₃ 98.5 | NaNO₃ 98.5 | | NaNO₃ 98.5 | |
| exchange | | | | LiNO₃ 1.5 | LiNO₃ 1.5 | | LiNO₃ 1.5 | |
| | Temperature (° C.) | 420° | C. | 390° C. | 390° | C. | 390° | C. |
| | Time | 100 | min | 5 h | 5 | h | 5 | h |
| Second ion | Second molten salt composition (mass %) | KNO₃ 99.4 | | — | KNO₃ 99.8 | | KNO₃ 99.92 | |
| exchange | | LiNO₃ 0.6 | | | LiNO₃ 0.2 | | LiNO₃ 0.08 | |
| | Temperature (° C.) | 400° | C. | — | 410° | C. | 410° | C. |
| | Time | 100 | min | — | 3 | h | 1 | h |

| | | | | | |
|---|---|---|---|---|---|
| | {LiNO₃ (mass %)}/{(Na₂O + Li₂O (mass %)} | 0.0638 | — | 0.0159 | 0.0063 |
| | Tn/Ts | 1 | — | 0.6 | 0.2 |
| Center in | Absolute value of difference between CT | 4.3 | 8.1 | 3.1 | 1.4 |
| thickness | values of effective stress and estimated | | | | |
| direction | stress (MPa) | | | | |
| | CT of effective stress (MPa) | −69.4 | −95.7 | −80.7 | −108.6 |
| | CT of estimated stress (MPa) | −65.1 | −103.8 | −83.8 | −107.2 |
| Depth of 10 μm | CS₁₀ difference (MPa) | 16.2 | −19.8 | 24.4 | 43.2 |
| | CS₁₀ of effective stress (MPa) | 93.1 | 472.2 | 193.5 | 308.0 |
| | CS₁₀ of estimated stress (MPa) | 109.3 | 452.5 | 217.9 | 351.2 |
| Depth of 15 μm | CS₁₅ difference (MPa) | 9.9 | −41.0 | 21.5 | 32.4 |
| | CS₁₅ of effective stress (MPa) | 100.5 | 443.5 | 190.7 | 305.7 |
| | CS₁₅ of estimated stress (MPa) | 110.4 | 402.5 | 212.2 | 338.1 |
| Effective stress | Slope at 15 μm (MPa/μm) | −0.4 | −6.4 | −0.6 | −1.1 |
| | Slope at 150 μm (MPa/μm) | −1.0 | −0.1 | −1.3 | −0.9 |
| Estimated stress | Slope at 15 μm (MPa/μm) | 0.4 | −8.6 | −0.6 | −2.0 |
| | Slope at 150 μm (MPa/μm) | −0.8 | −0.5 | −1.1 | −1.2 |
| Effective stress | CS₂₀ (MPa) | 98.8 | 406.2 | 187.7 | 298.2 |
| | CS₅₀ (MPa) | 91.2 | 170.3 | 162.8 | 208.3 |
| | CS₅₀/CS₂₀ | 0.92 | 0.42 | 0.87 | 0.70 |
| | CS₅₀ − CS₂₀ (MPa) | −7.57 | −235.91 | −24.91 | −89.93 |
| | CS₉₀ (MPa) | 64.38 | −23.07 | 88.57 | 45.97 |
| | CS₉₀/CS₂₀ | 0.65 | −0.06 | 0.47 | 0.15 |
| | CS₉₀ − CS₂₀ (MPa) | −34.40 | −429.26 | −99.17 | −252.26 |

| | | | | |
|---|---|---|---|---|
| Drop strength (cm) | 50 | 25 | 60 | 45 |

| | | Example 5 | | Example 6 | | Example 7 | |
|---|---|---|---|---|---|---|---|
| Glass material | | A | | A | | A | |
| Glass material | Li concentration (mass %) | 10.5 | | 10.5 | | 10.5 | |
| Thickness (mm) | | 0.703 | | 0.703 | | 0.7 | |
| First ion | First molten salt composition (mass %) | NaNO₃ 99.8 | | NaNO₃ 100 | | NaNO₃ 100 | |
| exchange | | LiNO₃ 0.2 | | | | | |
| | Temperature (° C.) | 390° | C. | 390° | C. | 390° | C. |
| | Time | 5 | h | 5 | h | 5 | h |
| Second ion | Second molten salt composition (mass %) | KNO₃ 99.8 | | KNO₃ 99.8 | | KNO₃ 99.8 | |
| exchange | | LiNO₃ 0.2 | | LiNO₃ 0.2 | | LiNO₃ 0.2 | |
| | Temperature (° C.) | 410° | C. | 410° | C. | 410° | C. |
| | Time | 1 | h | 1 | h | 1 | h |

| | | | | |
|---|---|---|---|---|
| | {LiNO₃ (mass %)}/{(Na₂O + Li₂O (mass %)} | 0.0159 | 0.0159 | 0.0159 |
| | Tn/Ts | 0.2 | 0.2 | 0.2 |
| Center in | Absolute value of difference between CT | 0.1 | 0.3 | 5.2 |
| thickness | values of effective stress and estimated | | | |
| direction | stress (MPa) | | | |
| | CT of effective stress (MPa) | −88.9 | −142.7 | −73.1 |
| | CT of estimated stress (MPa) | −88.7 | −142.4 | −67.9 |
| Depth of 10 μm | CS₁₀ difference (MPa) | 85.1 | 112.2 | 118 |
| | CS₁₀ of effective stress (MPa) | 230.7 | 382.3 | 230.8 |
| | CS₁₀ of estimated stress (MPa) | 315.8 | 494.5 | 348.8 |
| Depth of 15 μm | CS₁₅ difference (MPa) | 71.2 | 112.2 | 98.6 |
| | CS₁₅ of effective stress (MPa) | 233.1 | 382.3 | 233.3 |
| | CS₁₅ of estimated stress (MPa) | 304.3 | 494.5 | 331.9 |
| Effective stress | Slope at 15 μm (MPa/μm) | 0.4 | 0.8 | 0.3 |
| | Slope at 150 μm (MPa/μm) | −1.0 | −1.7 | −1.4 |
| Estimated stress | Slope at 15 μm (MPa/μm) | −1.8 | −4.9 | −2.0 |
| | Slope at 150 μm (MPa/μm) | −0.2 | −0.6 | −1.7 |
| Effective stress | CS₂₀ (MPa) | 234.2 | 390.5 | 187.0 |
| | CS₅₀ (MPa) | 199.6 | 290.5 | 208.0 |
| | CS₅₀/CS₂₀ | 0.85 | 0.74 | 1.11 |
| | CS₅₀ − CS₂₀ (MPa) | −34.57 | −99.92 | 21.00 |
| | CS₉₀ (MPa) | 67.01 | 91.48 | 105.00 |
| | CS₉₀/CS₂₀ | 0.29 | 0.23 | 0.56 |
| | CS₉₀ − CS₂₀ (MPa) | −167.19 | −298.98 | −82.00 |

| | | | |
|---|---|---|---|
| Drop strength (cm) | 55 | 60 | 65 |

As shown in Table 2, in Examples 5-7 that are Inventive Examples, the absolute value of the difference between the estimated stress profile and the effective stress profile at the center in a thickness direction was 30 MPa or smaller and a value obtained by subtracting, at a depth of 15 μm from the chemically strengthened surface, a compressive stress value of the effective stress profile from a compressive stress value of the estimated stress profile was 50 MPa or larger. It is therefore seen that the drop strengths of Inventive Examples ware higher than the drop strengths of Comparative Examples.

Examples 5-7 that are Inventive Examples show high strengths in spite of the fact that the second ion exchange time was half of the first ion exchange time or shorter, and hence were higher in productivity compared with conventional cases. Furthermore, since Examples 5-7 were suppressed in the reduction of the Na ion concentration in glass surface layers and high in electrostatic propensity, they were also high in the film formability of antifouling films.

If the strengthening is repeated under the strengthening conditions shown in Table 2, alkali metal ions came out of the glass by the ion change start to dissolve into the molten salt. This state that the salt concentration of the molten salt varies is called “salt degradation”, advanced salt degradation may not satisfy expected stress. The molten salt used in the first ion exchange and the molten salt used in the second ion exchange each are replaced at a timing when the salt degradation is confirmed. The salt degradation is judged on the basis of one or both of a stress value after the first ion exchange and a stress value after the second ion exchange to be reflected in a salt replacement or switched to another strengthening condition.

Although the above-mentioned instrument “SLP-1000,” for example, can be employed for the stress value, this value may be evaluated using a method disclosed in WO2020/045093 (hereinafter, abbreviated as “method A”). In a case of performing the evaluation by the method A, a plurality of parameters may be produced based on information of the salt degradation and the strengthening conditions, in other words, information of the first ion exchange and the second ion exchange. These may be pieces of salt degradation information of the first ion exchange and the second ion exchange, pieces of strengthening time information of the first ion exchange and the second ion exchange, or pieces of strengthening temperature information of the first ion exchange and the second ion exchange; these parameters may be plurally divided based on these pieces of information.

Although the following is employed in many cases: after completion of the first ion exchange, the glass is water-washed and dried, and then the second ion exchange is performed, another case may be employed: after completion of the first ion exchange, glass is immersed in a molten salt that is relatively low in temperature, and similar in composition to the molten salt in the second ion exchange (hereinafter, abbreviated as “prewashing”), and then the second ion exchange is performed without water washing. In this case, if the molten salt used in the prewashing is used repeatedly, the salt concentration may be changed because alkali metal ions contained in the molten salt of the first ion exchange start to dissolve thereinto. This state is also referred to as “salt degradation”, since it is necessary to replace the salt, timing of salt replacement is judged on the basis of the stress value after the prewashing or the second ion exchange. Although the above-mentioned instrument “SLP-1000,” for example, can be employed for the stress value, this value may be evaluated using the method A. In the case where the evaluation is performed using the method A, plural parameters may be produced on the basis of the information relating to the above-mentioned salt degradation conditions and strengthening conditions, in other words, prewashing information. Examples of these pieces of information include salt degradation information of the prewashing, immersion time information of the prewashing, and molten salt temperature information of the prewashing; these parameters may be plurally divided based on these pieces of information.

What is claimed is:

1. A chemically strengthened glass, satisfying:
in comparison of an estimated stress profile defined below with an effective stress profile defined below, an absolute value of a difference between tensile stress values at a center in a thickness direction being 30 MPa or smaller, and a value obtained by subtracting, at a depth of 15 μm from a chemically strengthened surface of the glass, a compressive stress value of the effective stress profile from a compressive stress value of the estimated stress profile being 50 MPa or larger, wherein
the estimated stress profile is a stress profile that is obtained from a Na ion concentration profile measured by an EPMA, the compressive stress value of the estimated stress profile is represented by σepma (MPa), and σepma (MPa) is obtained according to the following Equations (1) and (2), and
the effective stress profile is a stress profile that is measured by a birefringence imaging system Abrio, and the compressive stress value of the effective stress profile is represented by σact (MPa):
σepma=A×fepma+B (1)
Δ=σact−σepma (2), and
in Equation (1), fepma represents a compressive stress value in the Na ion concentration profile in the thickness direction of the chemically strengthened glass measured by the EPMA, and σepma is obtained by determining A and B in Equation (1) so as to minimize a square value of a difference Δ between the compressive stress values represented by Equation (2) in a portion deeper than a depth of 50 μm from the chemically strengthened surface.

2. The chemically strengthened glass according to claim 1, wherein the effective stress profile has a slope a₁₅ (MPa/μm) at a depth of 15 μm from the chemically strengthened surface satisfying a₁₅≥−1, and a slope a₁₅₀ at a depth of 150 μm from the chemically strengthened surface satisfying a₁₅₀<0.

3. The chemically strengthened glass according to claim 1, wherein the estimated stress profile has a slope e₁₅ (MPa/μm) at a depth of 15 μm from the chemically strengthened surface satisfying e₁₅<0, and a slope e₁₅₀ at a depth of 150 μm from the chemically strengthened surface satisfying e₁₅₀<0.

4. The chemically strengthened glass according to claim 1, wherein in the effective stress profile, a value obtained by subtracting a compressive stress value CS₂₀ at a depth of 20 μm from the chemically strengthened surface from a compressive stress value CS₅₀ at a depth of 50 μm from the chemically strengthened surface is −150 MPa or larger.

5. The chemically strengthened glass according to claim 1, wherein in the effective stress profile, a value obtained by subtracting a compressive stress value CS₂₀ at a depth of 20 μm from the chemically strengthened surface from a compressive stress value CS₉₀ at a depth of 90 μm from the chemically strengthened surface is −350 MPa or larger and 0 MPa or smaller.

6. The chemically strengthened glass according to claim 1, having a base composition comprising, by mass % in terms of oxides:
40% to 80% of SiO₂;
1% to 35% of Li₂O; and
1% to 20% of Al₂O₃.

7. The chemically strengthened glass according to claim 1, having a base composition comprising, by mass % in terms of oxides:
50% to 63% of SiO₂;
3% to 21% of Li₂O; and
5% to 19% of Al₂O₃.

8. The chemically strengthened glass according to claim 1, having a #80 drop strength of 40 cm or higher, the #80 drop strength being measured by a method of:
preparing a pseudo-smartphone by fitting a glass sample of 120 mm×60 mm×0.6 mm (thickness) into a structural body adjusted in mass and stiffness with respect to a smartphone having a common size;
dropping the pseudo-smartphone freely onto a #80 SiC sandpaper from a drop height of 5 cm;
dropping the pseudo-smartphone again after increasing the drop height by 5 cm if the glass sample is not broken;
repeating the dropping until the glass sample is broken; and
measuring an average of heights at which 10 individual glass samples are broken for the first time.

9. The chemically strengthened glass according to claim 1, being a crystallized glass.

10. The chemically strengthened glass according to claim 1, having a glass transition point Tg of 600° C. or lower at the center in the thickness direction.

11. A method for manufacturing a chemically strengthened glass, comprising:
bringing a lithium-containing glass whose glass transition point Tg at a center in a thickness direction is 600° C. or lower into contact with a molten salt composition to perform an ion exchange N times, N being an integer of 2 or larger, satisfying the following (a), (b-1) and (c):
(a) at least one of first to (N−1)th ion exchanges is an ion exchange of bringing the lithium-containing glass into contact with a first molten salt composition containing sodium nitrate, to obtain a glass having a compressive stress layer containing sodium ions;
(b-1) an Nth ion exchange is an ion exchange of bringing the glass having the compressive stress layer into contact with a second molten salt composition containing potassium nitrate and lithium nitrate, and a mass ratio of a content of lithium nitrate contained in the second molten salt composition to a total content, in terms of oxides, of sodium and lithium in a base composition of the glass having the compressive stress layer ((a mass concentration of LiNO₃ in the second molten salt composition)/(a (Na₂O+Li₂O) mass concentration in the base composition)), is 0.007 or higher; and
(c) a ratio Tn/Ts of a time Tn of the Nth ion exchange to the sum Ts of all times in the first to (N−1)th ion exchanges is 0.5 or lower.

12. A method for manufacturing a chemically strengthened glass, comprising: bringing a lithium-containing glass into contact with a molten salt composition to perform an ion exchange N times, N being an integer of 2 or larger, satisfying the following (a), (b-2) and (c):
(a) at least one of first to (N−1)th ion exchanges is an ion exchange of bringing the lithium-containing glass into contact with a first molten salt composition containing sodium nitrate to obtain a glass having a compressive stress layer containing sodium ions;
(b-2) an Nth ion exchange is an ion exchange of bringing the glass having the compressive stress layer into contact with a second molten salt composition containing potassium nitrate and lithium nitrate, and a temperature of the second molten salt composition in the Nth ion exchange is higher than or equal to a temperature of the second molten salt composition in the (N−1)th ion exchange; and
(c) a ratio Tn/Ts of a time Tn of the Nth ion exchange to the sum Ts of all times in the first to (N−1)th ion exchanges is 0.5 or lower.

13. The method for manufacturing a chemically strengthened glass according to claim 11, wherein temperatures of the first molten salt composition containing sodium nitrate and the second molten salt composition containing potassium nitrate and lithium nitrate are (Tg−300)° C. or higher and (Tg−10)° C. or lower, Tg being the glass transition point (° C.) of the lithium-containing glass at the center in a thickness direction.

14. The method for manufacturing a chemically strengthened glass according to claim 11, wherein temperatures of the first molten salt composition containing sodium nitrate and the second molten salt composition containing potassium nitrate and lithium nitrate are (0.5×Tg)° C. or higher and (0.9×Tg)° C. or lower, Tg being the glass transition point (° C.) of the lithium-containing glass at the center in a thickness direction.

15. The method for manufacturing a chemically strengthened glass according to claim 11, wherein the lithium-containing glass is a crystallized glass.

16. The method for manufacturing a chemically strengthened glass according to claim 12, wherein the lithium-containing glass has a glass transition point of 600° C. or lower at a center in a thickness direction.

17. The method for manufacturing a chemically strengthened glass according to claim 11, wherein the lithium-containing glass comprises, by mass % in terms of oxides:
40% to 80% of SiO₂;
1% to 35% of Li₂O; and
1% to 20% of Al₂O₃.

18. The method for manufacturing a chemically strengthened glass according to claim 11, wherein the lithium-containing glass comprises, by mass % in terms of oxides:
50% to 63% of SiO₂;
3% to 21% of Li₂O; and
5% to 19% of Al₂O₃.

19. The method for manufacturing a chemically strengthened glass according to claim 11, wherein in the feature of (b-1), a concentration of lithium nitrate contained in the second molten salt composition in the Nth ion exchange is 0.05 mass % or higher and 10 mass % or lower.

20. The method for manufacturing a chemically strengthened glass according to claim 11, wherein in the feature of (b-1), a mass ratio of potassium ions to lithium ions, potassium ions/lithium ions, contained in the second molten salt composition in the Nth ion exchange is 100 or higher and 1,249 or lower.
